(19) United States
(12) Patent Application Publication
(10) Pub. No.: US 2003/0003900 A1
(43) Pub. Date: Jan. 2, 2003

(54) Proximity-based call forwarding

(76) Inventors: Stephen C. Goss, Wheaton, IL (US); Phillip Michael Sands, Champaign, IL (US)

Correspondence Address: Docket Administrator (Room 3C-512), Lucent Technologies Inc., 600 Mountain Avenue, P.O. Box 636, Murray Hill, NJ, 07974-0636, US

(21) Appl. No.: 09/896,600

(22) Filed: Jun. 29, 2001

(51) Int. Cl. H04M 3/42

(52) U.S. Cl. 455/417; 455/445; 455/414

(57) ABSTRACT

A method and apparatus of call forwarding is presented whereby a wireless phone and one or more landline phones are equipped and programmed to perform call forwarding activation and de-activation automatically, without user intervention, based on geographic proximity relationships between the phones. When the wireless phone is not in near-proximity to any of the landline phones, calls to the landline phones are forwarded to the wireless phone. When the wireless phone comes in near-proximity to one of the landline phones, all calls to the wireless phone—including calls forwarded from other phones—are forwarded to the nearby landline phone. When the wireless phone subsequently leaves the nearby landline phone, all calls are sent to the wireless phone again. Advantageously, this arrangement overcomes numerous problems associated with manual activation and de-activation of call forwarding. In addition, the arrangement is entirely handset-based and requires no changes to network infrastructure, software, or established call forwarding procedures.

### FIELD OF THE INVENTION

The present invention relates generally to the forwarding of calls within a telecommunications system, and specifically to the automatic forwarding of calls from one or more phones to another phone, based on the geographic proximity between the phones.

### BACKGROUND OF THE INVENTION

It is common for wireless phone users such as cellular phone subscribers to carry their wireless phones at home, in the office, and at other places where landline phones are available for use. At such locations, it is to the advantage of the user to have wireless calls forwarded to a nearby landline phone, since landline service is typically less expensive. For example, when a cellular subscriber with call forwarding service arrives at the office, he/she would benefit by manually activating call forwarding so that calls intended for the wireless phone are automatically forwarded to the office phone. The activation process typically involves the user dialing a phone number and/or a feature code to activate call forwarding. Also, the user must typically enter a phone number to which calls are to be transferred.

A number of problems arise with the manual activation of call forwarding. To start, the user must remember the activation phone number and/or the feature code. In addition, manual activation takes time and is cumbersome—typically, the user must dial the activation phone number and/or feature code, wait for a system response, and then enter the forwarding number. Another problem is that the user must remember to activate the service. If the user is preoccupied or distracted, he/she may very well forget to activate call forwarding, resulting in receiving a call at a wireless phone that would have been more economical to take at a landline phone. Yet another problem that would typically occur in situations similar to the example stated above, is that the user must remember to de-activate call forwarding on the cellular phone when leaving the proximity of the office phone, to run an errand for example. If the user forgets to de-activate, he/she could miss important calls to the cellular phone. And even if the user does remember to de-activate call forwarding on the cellular phone, the user is faced with the problematic temptation to activate call forwarding on the office phone so that calls intended for the office phone are forwarded to the wireless phone. That manual activation is subject to its own set of problems analogous to those already stated. In short, it is easy to forget or forego the manual activation and de-activation of call forwarding on one phone, and it would be an outright annoyance to have to activate and de-activate call forwarding on multiple phones every time you go to the copy machine, run down the hall to pick up a report, or take some other short excursion away from your office.

Therefore, a need exists for a method and apparatus that allows for the forwarding of calls between wireless and landline phones automatically, without user interaction.

### BRIEF SUMMARY OF THE INVENTION

The present invention enables the automatic forwarding of calls between wireless and landline phones, based on the geographic proximity relationship between the phones. An exemplary embodiment of the present invention works as follows. Wireless phones and landline phones that provide automatic call forwarding are each equipped with a low-range radio transceiver, in addition to their traditional hardware and software components. Control programs operating within the wireless phones and the landline phones are further modified so that the phones attempt to establish communications with each other via the low-range radio transceivers. Call forwarding activation sequences are automatically performed by the wireless and landline phones, based on the ability or inability to establish communications between similarly enabled devices via the low-range radio transceivers. The user can also, upon entry of a code into one of the wireless phones or the landline phones, temporarily suspend automatic call forwarding.

The present invention therefore provides the ability for users to have call forwarding activated automatically based the proximity of the involved phones without having to remember to activate or de-activate call forwarding. In addition, users do not have to remember activation phone numbers or feature codes. These need to be programmed only once by the manufacturer or by the user, at set-up time. Further, the present invention allows users the ability to temporarily suspend automatic call forwarding. Another significant advantage of the present invention is that no network hardware, software, or feature protocol changes are required to implement this invention. Sensing the need to forward calls and performing the procedures to forward calls are carried out entirely within the involved phones.

### BRIEF DESCRIPTION OF THE SEVERAL VIEWS OF THE DRAWINGS

FIG. 1 depicts a communication system for providing proximity-based call forwarding in accordance with the present invention.

### DETAILED DESCRIPTION OF THE INVENTION

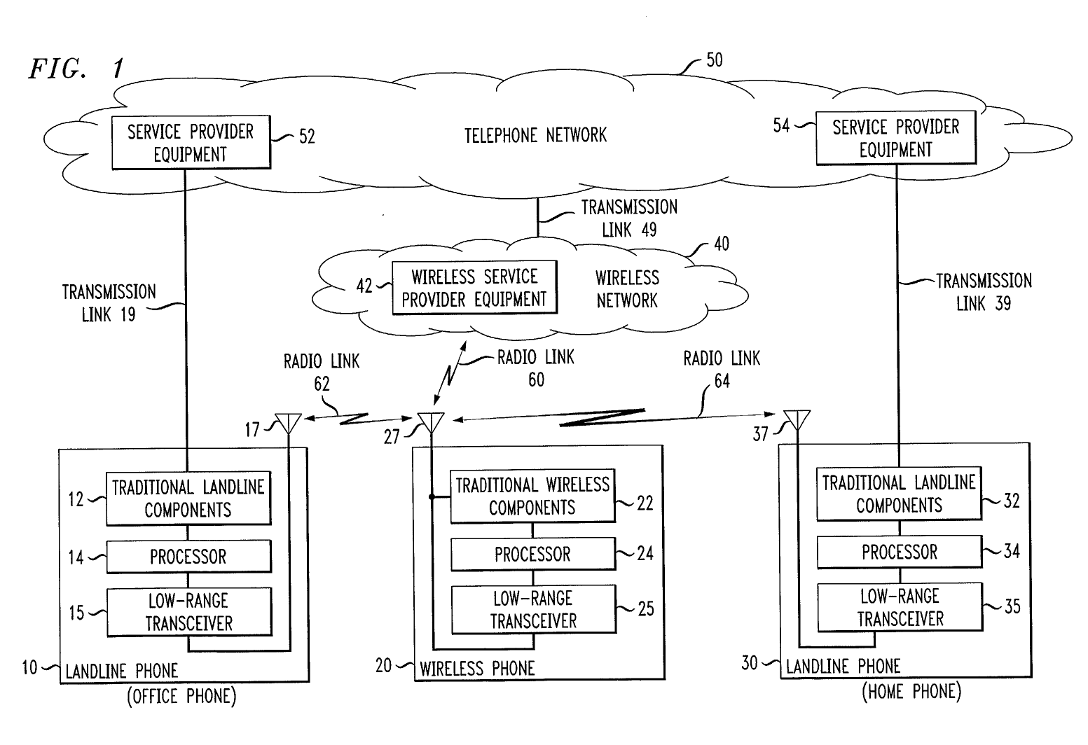

The present invention can be better understood with reference to FIG. 1. FIG. 1 depicts a communication system in accordance with the present invention. Phone 10 is a landline phone comprising traditional landline hardware/software components 12, processor 14, low-range transceiver 15, and antenna 17. The user of phone 10 can use traditional landline components 12, which includes a keypad and optional display, not shown, to place and receive calls to and from telephone network 50, and to manually activate and de-activate call forwarding by calling service provider equipment 52 and using established procedures. Telephone network 50 can be the Public Switched Telephone Network or some other public or private network. Service provider equipment 52 includes a switch and possibly other equipment, not shown, necessary to facilitate call forwarding.

Processor 14 in phone 10 runs a program to facilitate Automatic Call Forwarding (ACF) in accordance with the present invention. Although illustrated in FIG. 1 as a separate component, processor 14 can in fact be a processor included in traditional components 12. Processor 14 passes messages to low-range transceiver 15 for transmission. For example, a “beacon message” can be transmitted to notify other phones in nearby proximity that phone 10 is equipped to provide automatic call forwarding. Other messages can be used to pass information to nearby phones that are similarly capable, as discussed later. Transceiver 15 also receives beacon messages and other messages from nearby, similarly capable phones and passes them to processor 14 for processing. Transceiver 15 transmits and receives signals through antenna 17.

In an exemplary embodiment of the present invention, low-range transceivers 15, 25, and 35 utilize Bluetooth technology. Bluetooth is a wireless personal area network (PAN) technology from the Bluetooth Special Interest Group. Bluetooth is an open standard for short-range transmission of digital voice and data between mobile devices, such as laptops, PDAs, and phones, and desktop devices. Bluetooth supports point-to-point and multipoint applications. Bluetooth provides up to 720 Kbps data transfer within a range of 10 meters and up to 100 meters with a power boost. Bluetooth uses omnidirectional radio waves that can transmit through walls and other non-metal barriers. Bluetooth transmits in the unlicensed 2.4 GHz band and uses a frequency hopping spread spectrum technique that changes its signal 1600 times per second.

Phone 30 is a landline phone, similar to phone 10, with components analogous to those of Phone 10.

Wireless phone 20 comprises traditional wireless hardware/software components 22, processor 24, low-range transceiver 25, and antenna 27. Wireless phone 20 may be a cellular phone or some other wireless device. The user of phone 20 can use traditional wireless components 22, which includes a keypad and optional display, not shown, to place and receive calls to and from wireless network 40, and to manually activate and de-activate call forwarding through wireless service provider equipment 42, using established procedures. Wireless network 40 can be a cellular network or some other public or private wireless network. Wireless service provider equipment 42 includes a radio base station, a switch, and possibly other equipment, not shown, needed to facilitate call forwarding. Processor 24 runs a program to facilitate Automatic Call Forwarding (ACF) in accordance with the present invention.

Although illustrated in FIG. 1 as a separate component, processor 24 can in fact be a processor included in traditional wireless components 22. Low-range transceiver 25 is used to communicate with low-range transceiver 15 of phone 10 and with low-range transceiver 35 of phone 30, sending and receiving beacon messages and other messages that come from and go to processor 24. Transceiver 25 transmits and receives signals through antenna 27 which may be duplexed to operate with transceiver 25 and with the traditional wireless components 22, as illustrated in FIG. 1, or antenna 27 may be a separate antenna dedicated to low-range transceiver 25.

When phones 10, 20 and 30 are first installed, they need to be programmed with call forwarding details. Typically, each phone needs to be programmed with the phone number and/or feature code needed to activate call forwarding, and each phone needs to be programmed with the forwarded phone number. In addition, each phone needs to be programmed with the conditions that trigger activation and de-activation of automatic call forwarding.

While the programming of call forwarding details can be relatively straightforward, different trigger conditions and many variations in the sequencing of data entry are possible. Manufacturers may choose to sell multiple phones that are pre-programmed to implement automatic call forwarding when the phones come in near proximity of one another. Alternately, programs running within a phone can be activated to implement call forwarding with a similarly equipped phone upon the receipt of the first beacon message from the similarly-equipped phone.

Once a set of phones is programmed to work with each other, call forwarding between the phones is automatic, based on the proximity relationships of the phones. For example, consider FIG. 1 again. Preferably, phones 10 and 30 are initially programmed to forward calls to wireless phone 20 whenever phone 20 is outside the range of the low-range transceivers in phones 10 and 30. Thus, if a user has his/her cell phone in the car on the way to the office, calls intended for any of the three phones will be sent to wireless phone 20. Later, when wireless phone 20 comes in near proximity to landline phone 10 (at the office, for example), phone 10 and phone 20 will pick up each other's beacon message over 2-way radio link 62 and respond according to its own programming. The programming in landline phone 10 preferably directs landline phone 10 to de-activate call forwarding to phone 20, so that phone 10 can receive it's own calls. The de-activation is preferably carried out by processor 14, which directs conventional components 12 to access service provider equipment 52 over transmission link 19. Once connected, phone 10 sends the de-activation code to service provider equipment 52, using the established protocol to de-activate call forwarding, producing the same result a user would achieve if he/she manually deactivated call forwarding using the keypad included in conventional components 12.

The programming in wireless phone 20 preferably directs wireless phone 20 to activate call forwarding to phone 10. Processor 24 within phone 20 controls this by using traditional wireless components 22 to access service provider equipment 42 over radio link 60, and by carrying out the established procedure to activate call forwarding to phone 10. Thus, when phones 10 and 20 remain in proximity of one another, phone 10 receives its own calls as well all calls to phone 20—including the calls forwarded to phone 20 from phone 30.

Let's continue the example by considering what happens when wireless phone 20 leaves the proximity of phone 10. This could occur when the user leaves the office to go on an errand or to go home. When the low-range transceivers go out of each other's range, phones 10 and 20 will sense the loss of each other's beacon message. In that situation, phone 20 will de-activate call forwarding to phone 10, and phone 10 will activate call forwarding to phone 20. Thus, all calls to all three phones will be sent to phone 20 again.

Continuing the example further, consider what happens if the user brings phone 20 within near proximity of phone 30 (at home, for example). Preferably processor 34 in phone 30 will interpret the presence of the beacon message from phone 20 over 2-way radio link 64 as a directive to de-activate call forwarding to phone 20. Phone 30 will de-activate in a manner analogous to how Phone 10 deactivated call forwarding to phone 20, as discussed earlier. Similarly, phone 20 will interpret the presence of the beacon message from phone 30 as a directive to activate call forwarding of its calls to phone 30, and will do so in a manner analogous to that discussed earlier.

An enhancement to this invention is to allow users to suspend the preprogrammed call activation defaults, and later re-instate the pre-programmed defaults. Consider the suspend case. In the preceding example, just before the user goes home, while low-range transceivers 15 and 25 are still receiving each other's beacon message, the user could enter a code using the keypad of phone 20 to suspend call forwarding. This would preferably result in phone 20 de-activating call forwarding to phone 10, even though phone 20 is in near-proximity of phone 10. In addition, processor 24 would direct low-range transceiver 25 to send a message to low-range transceiver 15 to direct phone 10 to not activate call forwarding when phone 20 subsequently leaves the near proximity of phone 10. The user could just as easily entered the suspend command using the keypad of phone 10. In that case, phone 10 would take note to not activate call forwarding when phone 20 goes out of proximity. Phone 10 will also send a message to phone 20, directing phone 20 to de-activate call forwarding to phone 10.

Thus, the present invention provides a method and apparatus for allowing phones to automatically forward calls intended for a first phone to a second phone based on the proximity of the phones to each other. In an exemplary embodiment, calls intended for a wireless phone while the wireless phone is in proximity to a landline phone are forwarded to the landline phone. This automatic call forwarding can be overridden by manually entering a key sequence into the wireless phone.

In accordance with a further exemplary embodiment of the present invention, when the wireless phone and the landline phone are no longer in proximity, calls intended for the wireless phone are no longer automatically forwarded to the landline phone. This is typically accomplished by having the wireless phone send a key sequence to the network infrastructure canceling the call forwarding.

In a further exemplary embodiment, upon leaving the proximity of the landline phone, calls now intended for the landline phone are automatically forwarded to the wireless phone. This is preferably done by sending a key sequence from the landline phone to the network infrastructure. This forwarding is done automatically, but can be overridden by entering a key sequence into the landline phone to cancel the automatic call forwarding.

While this invention has been described in terms of certain examples thereof, it is not intended that it be limited to the above description, but rather only to the extent set forth in the claims that follow.

We claim:

1. A method for automatically forwarding a call intended for a first phone to a second phone based upon the proximity of the first phone to the second phone, the method comprising the steps of:
detecting that the first phone is within range of the second phone; and
automatically forwarding calls intended for the first phone to the second phone upon detecting that the first phone is within range of the second phone.

2. A method for automatically forwarding a call in accordance with claim 1, the method further comprising detecting that the first phone is not within range of the second phone.

3. A method for automatically forwarding a call in accordance with claim 2, the method further comprising automatically forwarding calls intended for the second phone to the first phone upon detecting that the first phone is not within range of the second phone.

4. A method for automatically forwarding a call in accordance with claim 3, wherein automatic call forwarding is temporarily suspended upon entry of a code into the second phone.

5. A method for automatically forwarding a call in accordance with claim 1, the method further comprising deactivating automatically forwarding calls intended for the first phone to the second phone upon detecting that the first phone is not within range of the second phone.

6. A method for automatically forwarding a call in accordance with claim 5, wherein the step of deactivating is done by sending a predetermined key sequence from the first phone.

7. A method for automatically forwarding a call in accordance with claim 1, wherein the step of detecting that the first phone is within range of the second phone comprises receiving a signal sent from the second phone to the first phone.

8. A method for automatically forwarding a call in accordance with claim 7, wherein the step of receiving a signal sent from the second phone to the first phone comprises receiving a beacon message at the first phone from the second phone.

9. A method for automatically forwarding a call in accordance with claim 8, wherein the beacon message indicates that the first phone is equipped to provide automatic call forwarding.

10. A method for automatically forwarding a call in accordance with claim 8, wherein the beacon message indicates that the second phone is equipped to provide automatic call forwarding.

11. A method for automatically forwarding a call in accordance with claim 8, wherein the first beacon message received activates the automatic call-forwarding.

12. A method for automatically forwarding a call in accordance with claim 7, wherein the step of receiving a signal sent from the second phone to the first phone comprises receiving a low-range signal at the first phone.

13. A method for automatically forwarding a call in accordance with claim 1, wherein the step of automatically forwarding calls comprises performing, at the first phone, the steps necessary to activate call-forwarding.

14. A method for automatically forwarding a call in accordance with claim 13, wherein the step of performing, at the first phone, the steps necessary to activate call-forwarding comprises the step of sending the phone number of the first phone and the feature code needed to activate call forwarding.

15. A method for automatically forwarding a call in accordance with claim 1, the method further comprising programming the first phone with a forwarding phone number to which calls would be automatically forwarded.

16. A method for automatically forwarding a call in accordance with claim 15, wherein the forwarding phone number is the directory number of the second phone

17. A method for automatically forwarding a call in accordance with claim 1, the method further comprising the step of suspending the automatic forwarding of calls upon entering a pre-programmed key sequence in the first phone.

18. A method for automatically forwarding a call in accordance with claim 1, the method further comprising the step of suspending the automatic forwarding of calls upon entering a pre-programmed key sequence in the first phone

19. A phone that provides automatic call forwarding for calls intended for the phone, the phone comprising:
a low-range transceiver that receives a low-range signal, the low-range signal indicating the proximity of a second phone; and
a processor that sends a call forwarding activation signal to automatically forward calls intended for the phone to the second phone upon receiving the low-range signal.

20. A phone in accordance with claim 19, wherein the low-range signal includes an indication that the second phone is capable of receiving forwarded calls from the phone.

21. A phone in accordance with claim 19, wherein the low-range signal is a beacon message sent from the second phone.

22. A phone in accordance with claim 19, wherein the processor generates low-range signals to be transmitted by the low-range transceiver.

23. A phone in accordance with claim 22, wherein the low-range signals sent by the low-range transmitter are sent to indicate the presence of the phone.

24. A phone in accordance with claim 19, wherein the processor deactivates call forwarding of calls intended for the phone when the low-range transceiver ceases to receive a low-range signal.

25. A phone in accordance with claim 19, wherein the processor receives a code from an input device coupled to the phone, and wherein the code indicates that the phone should suspend the automatic call forwarding.

26. A phone in accordance with claim 25, wherein the processor deactivates call forwarding of calls intended for the phone in response to the receipt of the code.
